(19) United States
(12) Patent Application Publication
(10) Pub. No.: US 2014/0140392 A1
(43) Pub. Date: May 22, 2014

(54) VIDEO PROCESSING SYSTEM WITH PREDICTION MECHANISM AND METHOD OF OPERATION THEREOF

(71) Applicant: Sony Corporation, Tokyo (JP)

(72) Inventors: Jun Xu, Sunnyvale, CA (US); Ali Tabatabai, Cupertino, CA (US)

(21) Appl. No.: 14/040,598

(22) Filed: Sep. 27, 2013

Related U.S. Application Data
(60) Provisional application No. 61/727,189, filed on Nov. 16, 2012.
(60) Provisional application No. 61/749,729, filed on Jan. 7, 2013.

(51) Int. Cl. H04N 7/26

(52) U.S. Cl. CPC H04N 19/00018
USPC 375/240.02

(57) ABSTRACT

A video processing system, and a method of operation thereof, including: a source input module for receiving a frame from a video source; a left co-located prediction module, coupled to the source input module, for determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame; and a prediction mode module, coupled to the left co-located prediction module, for generating an intra mode based on the left intra direction to generate a video bitstream for a video decoder to display on a device.

### CROSS-REFERENCE TO RELATED APPLICATION(S)

This application claims the benefit of U.S. Provisional Patent Application Ser. No. 61/727,189 filed Nov. 16, 2012 and U.S. Provisional Patent Application Ser. No. 61/749,729 filed Jan. 7, 2013, and the subject matter thereof is incorporated herein by reference thereto.

### TECHNICAL FIELD

The present invention relates generally to a video processing system and more particularly to a system for prediction mechanism.

### BACKGROUND ART

The deployment of high quality video to smart phones, high definition televisions, automotive information systems, and other video devices with screens has grown tremendously in recent years. The wide variety of information devices supporting video content requires multiple types of video content to be provided to devices with different size, quality, and connectivity capabilities.

Video has evolved from two dimensional single view video to multi-view video with high-resolution three-dimensional imagery. In order to make the transfer of video more efficient, different video coding and compression schemes have tried to get the best picture from the least amount of data.

The Moving Pictures Experts Group (MPEG) developed standards to allow good video quality based on a standardized data sequence and algorithm. The MPEG4 Part 10 (H.264)/Advanced Video Coding design was an improvement in coding efficiency typically by a factor of two over the prior MPEG-2 format.

The quality of the video is dependent upon the manipulation and compression of the data in the video. The video can be modified to accommodate the varying bandwidths used to send the video to the display devices with different resolutions and feature sets. However, distributing larger, higher quality video or more complex video functionality requires additional bandwidth and improved video compression.

Thus, a need still remains for a video processing system that can deliver good picture quality and features across a wide range of device with different sizes, resolutions, and connectivity. In view of the increasing demand for providing video on the growing spectrum of intelligent devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a video processing system, including: receiving a frame from a video source; determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame; and generating a prediction mode based on the left intra direction to generate a video bitstream for a video decoder to display on a device.

The present invention provides a video processing system, including: a source input module for receiving a frame from a video source; a left co-located prediction module, coupled to the source input module, for determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame; and a prediction mode module, coupled to the left co-located prediction module, for generating a prediction mode based on the left intra direction to generate a video bitstream for a video decoder to display on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a system diagram of a video processing system in an embodiment of the present invention.

FIG. 2 is an example of the video bitstream.

FIG. 3 is an example of a coding tree unit.

FIG. 4 is an example of prediction units.

FIG. 5 is a hardware diagram of the video processing system.

FIG. 6 is an exemplary diagram illustrating derivation of prediction for intra modes of coding blocks.

FIG. 7 is an exemplary control flow of the prediction mechanism for the derivation of the prediction modes.

FIG. 8 is a flow chart of a method of operation of a video processing system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a microelectromechanical system (MEMS), passive devices, environmental sensors including temperature sensors, or a combination thereof.

The term “syntax” referred to herein means a set of elements describing a data structure. The term “block” referred to herein means a group of picture elements, pixels, or smallest addressable elements in a display device.

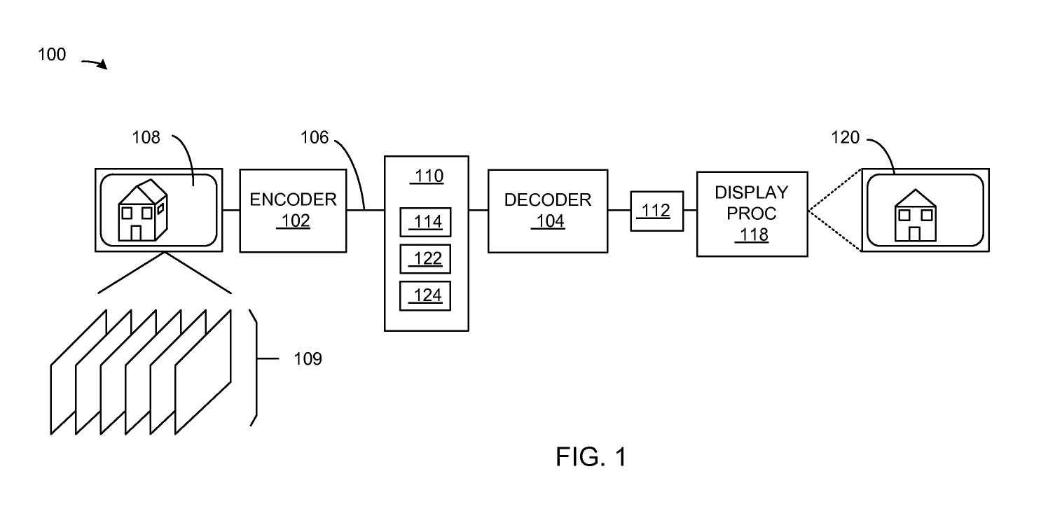

Referring now to FIG. 1, therein is shown a system diagram of a video processing system 100 in an embodiment of the present invention. The video processing system 100 can encode and decode video information. A video encoder 102 can receive a video source 108 and send a video bitstream 110 to a video decoder 104 for decoding and displaying on a display interface 120.

The video encoder 102 can receive and encode the video source 108. The video encoder 102 is a unit for encoding the video source 108 into a different form. The video source 108 is defined as a digital representation of a scene of objects.

Encoding is defined as computationally modifying the video source 108 to a different form. For example, encoding can compress the video source 108 into the video bitstream 110 to reduce the amount of data needed to transmit the video bitstream 110.

In another example, the video source 108 can be encoded by being compressed, visually enhanced, separated into one or more views, changed in resolution, changed in aspect ratio, or a combination thereof. In another illustrative example, the video source 108 can be encoded according to the High-Efficiency Video Coding (HEVC)/H.265 standard. In yet another illustrative example, the video source 108 can be further encoded to increase spatial scalability.

The video source 108 can include frames 109. The frames 109 are individual images that form the video source 108. For example, the video source 108 can be the digital output of one or more digital video cameras taking any number including 24 of the frames 109 per second.

The video encoder 102 can encode the video source 108 to form the video bitstream 110. The video bitstream 110 is defined a sequence of bits representing information associated with the video source 108. For example, the video bitstream 110 can be a bit sequence representing a compression of the video source 108.

In an illustrative example, the video bitstream 110 can be a serial bitstream sent from the video encoder 102 to the video decoder 104. In another illustrative example, the video bitstream 110 can be a data file stored on a storage device and retrieved for use by the video decoder 104.

The video encoder 102 can receive the video source 108 for a scene in a variety of ways. For example, the video source 108 representing objects in the real world can be captured with a video camera, multiple cameras, generated with a computer, provided as a file, or a combination thereof.

The video source 108 can include a variety of video features. For example, the video source 108 can include single view video, multiview video, stereoscopic video, or a combination thereof.

The video encoder 102 can encode the video source 108 using a video syntax 114 to generate the video bitstream 110. The video syntax 114 is defined as a set of information elements that describe a coding system for encoding and decoding the video source 108.

The video bitstream 110 is compliant with the video syntax 114, including High-Efficiency Video Coding/H.265. For example, the video syntax 114 can include a HEVC video bitstream, an Ultra High Definition video bitstream, or a combination thereof. The video bitstream 110 can include the video syntax 114.

The video bitstream 110 can include information representing the imagery of the video source 108 and the associated control information related to the encoding of the video source 108. For example, the video bitstream 110 can include an occurrence of the video syntax 114 and an occurrence of the video source 108.

The video encoder 102 can encode the frames 109 in the video source 108 to form a base layer 122 (BL) and enhancement layers 124 (EL). The base layer 122 is a representation of the video source 108. For example, the base layer 122 can include the video source 108 at a different resolution, quality, bit rate, frame rate, or a combination thereof.

The base layer 122 can be a lower resolution representation of the video source 108. In another example, the base layer 122 can be a High Efficiency Video Coding (HEVC) representation of the video source 108. In yet another example, the base layer 122 can be a representation of the video source 108 configured for a smart phone display.

The enhancement layers 124 are representations of the video source 108 based on the video source 108 and the base layer 122. The enhancement layers 124 can be higher quality representations of the video source 108 at different resolutions, quality, bit rates, frame rates, or a combination thereof. The enhancement layers 124 can be higher resolution representations of the video source 108 than the base layer 122.

The video processing system 100 can include the video decoder 104 for decoding the video bitstream 110. The video decoder 104 is defined as a unit for receiving the video bitstream 110 and modifying the video bitstream 110 to form a video stream 112.

The video decoder 104 can decode the video bitstream 110 to form the video stream 112 using the video syntax 114. Decoding is defined as computationally modifying the video bitstream 110 to form the video stream 112. For example, decoding can decompress the video bitstream 110 to form the video stream 112 formatted for displaying on the display the display interface 120.

The video stream 112 is defined as a computationally modified version of the video source 108. For example, the video stream 112 can include a modified occurrence of the video source 108 with different resolution. The video stream 112 can include cropped decoded pictures from the video source 108.

The video decoder 104 can form the video stream 112 in a variety of ways. For example, the video decoder 104 can form the video stream 112 from the base layer 122. In another example, the video decoder 104 can form the video stream 112 from the base layer 122 and one or more of the enhancement layers 124.

In a further example, the video stream 112 can have a different aspect ratio, a different frame rate, different stereoscopic views, different view order, or a combination thereof than the video source 108. The video stream 112 can have different visual properties including different color parameters, color planes, contrast, hue, or a combination thereof.

The video processing system 100 can include a display processor 118. The display processor 118 can receive the video stream 112 from the video decoder 104 for displaying on the display interface 120. The display interface 120 is a unit that can present a visual representation of the video stream 112.

For example, the display interface 120 can include a smart phone display, a digital projector, a DVD player display, or a combination thereof. Although the video processing system 100 shows the video decoder 104, the display processor 118, and the display interface 120 as individual units, it is understood that the video decoder 104 can include the display processor 118 and the display interface 120.

The video encoder 102 can send the video bitstream 110 to the video decoder 104 in a variety of ways. For example, the video encoder 102 can send the video bitstream 110 to the video decoder 104 over a communication path 106. In another example, the video encoder 102 can send the video bitstream 110 as a data file on a storage device. The video decoder 104 can access the data file to receive the video bitstream 110.

The communication path 106 can be a variety of networks suitable for data transfer. For example, the communication path 106 can include wireless communication, wired communication, optical, infrared, or the combination thereof.

Satellite communication, cellular communication, terrestrial communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), digital television, and plain old telephone service (POTS) are examples of wired communication that can be included in the communication path 106.

The video processing system 100 can employ a variety of video coding syntax structures. For example, the video processing system 100 can encode and decode video information using High Efficiency Video Coding/H.265 (HEVC), scalable extensions for HEVC, or other video coding syntax structures.

The video encoder 102 and the video decoder 104 can be implemented in a variety of ways. For example, the video encoder 102 and the video decoder 104 can be implemented using hardware, software, or a combination thereof. For example, the video encoder 102 can be implemented with custom circuitry, a digital signal processor, microprocessor, or a combination thereof. In another example, the video decoder 104 can be implemented with custom circuitry, a digital signal processor, microprocessor, or a combination thereof.

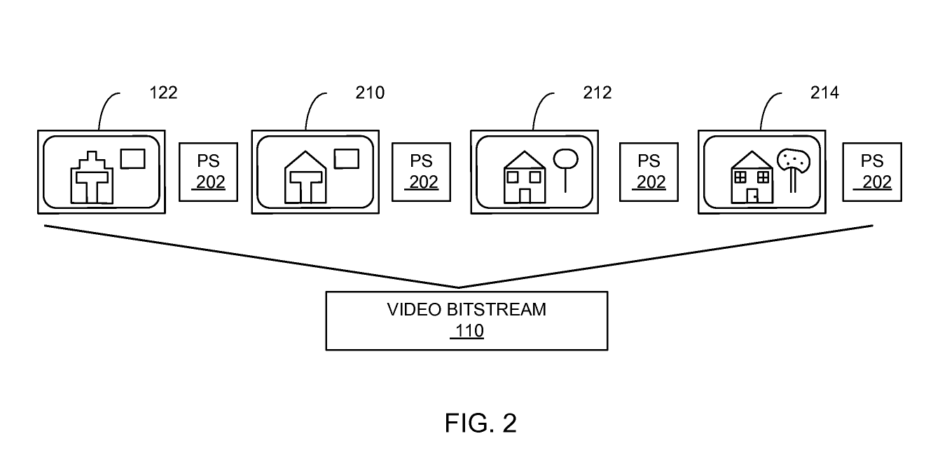

Referring now to FIG. 2, therein is shown an example of the video bitstream 110. The video bitstream 110 includes an encoded occurrence of the video source 108 of FIG. 1 and can be decoded to form the video stream 112 of FIG. 1 for displaying on the display interface 120 of FIG. 1.

The video bitstream 110 can include the base layer 122 and the enhancement layers 124 of FIG. 1 based on the video source 108. The video bitstream 110 can include one of the frames 109 of FIG. 1 of the base layer 122 followed by a parameter set 202 associated with the base layer 122.

The video bitstream 110 can include the frames 109 of the enhancement layers 124. For example, the enhancement layers 124 can include the frames 109 from a first enhancement layer 210, a second enhancement layer 212, and a third enhancement layer 214. Each of the frames 109 of the enhancement layers 124 can be followed by the parameter set 202 associated with one of the enhancement layers 124.

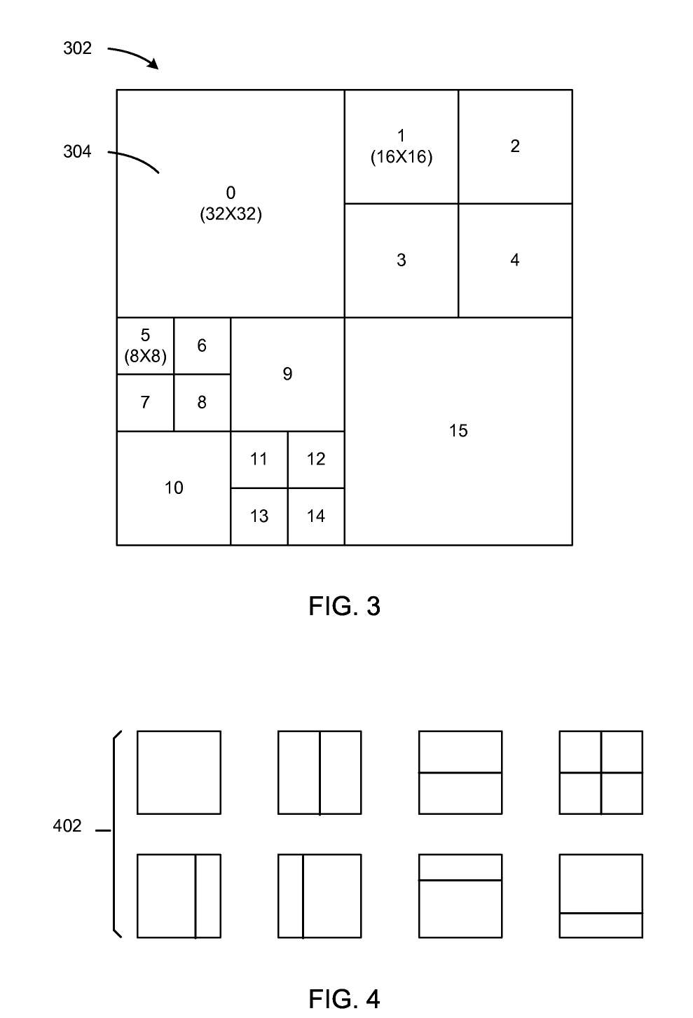

Referring now to FIG. 3, therein is shown an example of a coding tree unit 302. The coding tree unit 302 is a basic unit of video coding.

The video source 108 of FIG. 1 can include the frames 109 of FIG. 1. Each of the frames 109 can be encoded into the coding tree unit 302.

The coding tree unit 302 can be subdivided into coding units 304 using a quadtree structure. The quadtree structure is a tree data structure in which each internal mode has exactly four children. The quadtree structure can partition a two dimensional space by recursively subdividing the space into four quadrants.

The frames 109 of the video source 108 can be subdivided into the coding units 304. The coding units 304 are square regions that make up one of the frames 109 of the video source 108.

The coding units 304 can be a variety of sizes. For example, the coding units 304 can be up to 64×64 pixels in size. Each of the coding units 304 can be recursively subdivided into four more of smaller units with sizes smaller than those of the coding units 304. In another example, the coding units 304 having 64×64 pixels can include the smaller units having 32×32 pixels, 16×16 pixels, or 8×8 pixels.

Referring now to FIG. 4, therein is shown an example of prediction units 402. The prediction units 402 are regions within the coding units 304 of FIG. 3. The contents of the prediction units 402 can be calculated based on the content of other adjacent regions of pixels. The prediction units 402 can include the smaller units previously described.

Each of the prediction units 402 can be calculated in a variety of ways. For example, the prediction units 402 can be calculated using intra-prediction or inter-prediction.

The prediction units 402 calculated using intra-prediction can include content based on neighboring regions. For example, the content of the prediction units 402 can be calculated using an average value, by fitting a plan surface to one of the prediction units 402, direction prediction extrapolated from neighboring regions, or a combination thereof.

The prediction units 402 calculated using inter-prediction can include content based on image data from the frames 109 of FIG. 1 that are nearby. For example, the content of the prediction units 402 can include content calculated using previous frames or later frames, content based on motion compensated predictions, average values from multiple frames, or a combination thereof.

The prediction units 402 can be formed by partitioning one of the coding units 304 in one of eight partition modes. The coding units 304 can include one, two, or four of the prediction units 402. The prediction units 402 can be rectangular or square.

For example, the prediction units 402 can be represented by mnemonics 2N×2N, 2N×N, N×2N, N×N, 2N×nU, 2N×nD, nL×2N, and nR×2N. Uppercase “N” can represent half the length of one of the coding units 304. Lowercase “n” can represent one quarter of the length of one of the coding units 304. Uppercases “R” and “L” can represent right or left respectively. Uppercase “U” and “D” can represent up and down respectively.

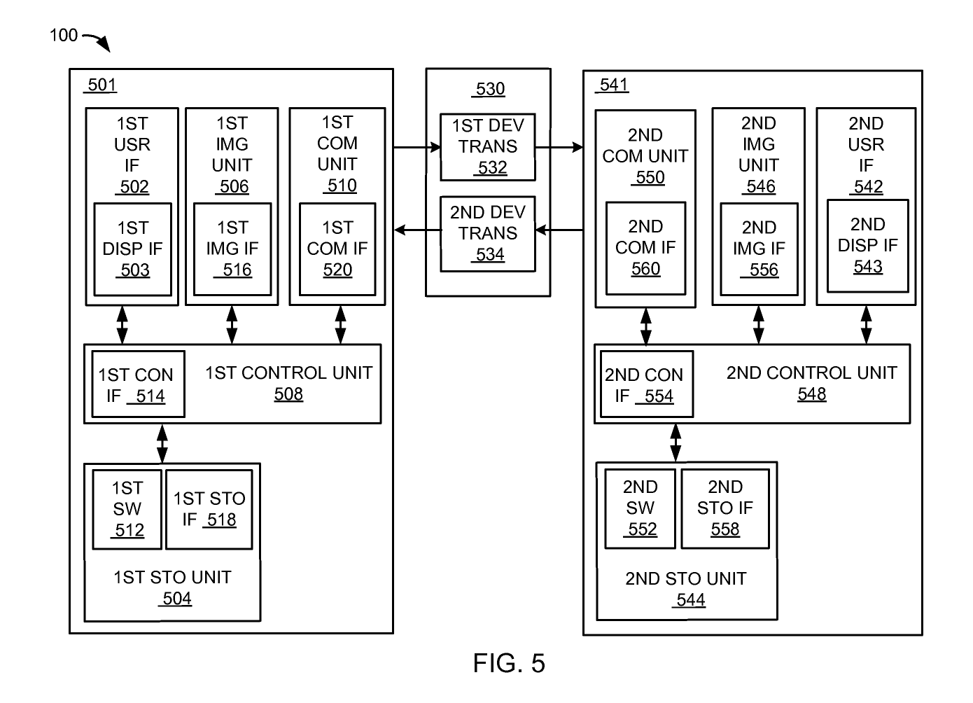

Referring now to FIG. 5, therein is shown a hardware diagram of the video processing system 100. The video processing system 100 can include a first device 501, a second device 541, and a communication link 530.

The video processing system 100 can be implemented using the first device 501, the second device 541, and the communication link 530. For example, the first device 501 can implement the video encoder 102 of FIG. 1, the second device 541 can implement the video decoder 104 of FIG. 1, and the communication link 530 can implement the communication path 106 of FIG. 1. However, it is understood that the video processing system 100 can be implemented in a variety of ways and the functionality of the video encoder 102, the video decoder 104, and the communication path 106 can be partitioned differently over the first device 501, the second device 541, and the communication link 530.

The first device 501 can communicate with the second device 541 over the communication link 530. The first device 501 can send information in a first device transmission 532 over the communication link 530 to the second device 541. The second device 541 can send information in a second device transmission 534 over the communication link 530 to the first device 501.

For illustrative purposes, the video processing system 100 is shown with the first device 501 as a client device, although it is understood that the video processing system 100 can have the first device 501 as a different type of device. For example, the first device can be a server. In a further example, the first device 501 can be the video encoder 102, the video decoder 104, or a combination thereof.

Also for illustrative purposes, the video processing system 100 is shown with the second device 541 as a server, although it is understood that the video processing system 100 can have the second device 541 as a different type of device. For example, the second device 541 can be a client device. In a further example, the second device 541 can be the video encoder 102, the video decoder 104, or a combination thereof.

For brevity of description in this embodiment of the present invention, the first device 501 will be described as a client device, such as a video camera, smart phone, or a combination thereof. The present invention is not limited to this selection for the type of devices. The selection is an example of the present invention.

The first device 501 can include a first control unit 508. The first control unit 508 can include a first control interface 514. The first control unit 508 can execute a first software 512 to provide the intelligence of the video processing system 100.

The first control unit 508 can be implemented in a number of different manners. For example, the first control unit 508 can be a processor, an embedded processor, a microprocessor, a hardware control logic, a hardware finite state machine (FSM), a digital signal processor (DSP), or a combination thereof.

The first control interface 514 can be used for communication between the first control unit 508 and other functional units in the first device 501. The first control interface 514 can also be used for communication that is external to the first device 501.

The first control interface 514 can receive information from the other functional units or from external sources, or can transmit information to the other functional units or to external destinations. The external sources and the external destinations refer to sources and destinations external to the first device 501.

The first control interface 514 can be implemented in different ways and can include different implementations depending on which functional units or external units are being interfaced with the first control interface 514. For example, the first control interface 514 can be implemented with electrical circuitry, microelectromechanical systems (MEMS), optical circuitry, wireless circuitry, wireline circuitry, or a combination thereof.

The first device 501 can include a first storage unit 504. The first storage unit 504 can store the first software 512. The first storage unit 504 can also store the relevant information, such as images, syntax information, video, profiles, display preferences, sensor data, or any combination thereof.

The first storage unit 504 can be a volatile memory, a nonvolatile memory, an internal memory, an external memory, or a combination thereof. For example, the first storage unit 504 can be a nonvolatile storage such as non-volatile random access memory (NVRAM), Flash memory, disk storage, or a volatile storage such as static random access memory (SRAM).

The first storage unit 504 can include a first storage interface 518. The first storage interface 518 can be used for communication between the first storage unit 504 and other functional units in the first device 501. The first storage interface 518 can also be used for communication that is external to the first device 501.

The first device 501 can include a first imaging unit 506. The first imaging unit 506 can capture the video source 108 of FIG. 1 from the real world. The first imaging unit 506 can include a digital camera, a video camera, an optical sensor, or any combination thereof.

The first imaging unit 506 can include a first imaging interface 516. The first imaging interface 516 can be used for communication between the first imaging unit 506 and other functional units in the first device 501.

The first imaging interface 516 can receive information from the other functional units or from external sources, or can transmit information to the other functional units or to external destinations. The external sources and the external destinations refer to sources and destinations external to the first device 501.

The first imaging interface 516 can include different implementations depending on which functional units or external units are being interfaced with the first imaging unit 506. The first imaging interface 516 can be implemented with technologies and techniques similar to the implementation of the first control interface 514.

The first storage interface 518 can receive information from the other functional units or from external sources, or can transmit information to the other functional units or to external destinations. The external sources and the external destinations refer to sources and destinations external to the first device 501.

The first storage interface 518 can include different implementations depending on which functional units or external units are being interfaced with the first storage unit 504. The first storage interface 518 can be implemented with technologies and techniques similar to the implementation of the first control interface 514.

The first device 501 can include a first communication unit 510. The first communication unit 510 can be for enabling external communication to and from the first device 501. For example, the first communication unit 510 can permit the first device 501 to communicate with the second device 541, an attachment, such as a peripheral device or a computer desktop, and the communication link 530.

The first communication unit 510 can also function as a communication hub allowing the first device 501 to function as part of the communication link 530 and not limited to be an end point or terminal unit to the communication link 530. The first communication unit 510 can include active and passive components, such as microelectronics or an antenna, for interaction with the communication link 530.

The first communication unit 510 can include a first communication interface 520. The first communication interface 520 can be used for communication between the first communication unit 510 and other functional units in the first device 501. The first communication interface 520 can receive information from the other functional units or can transmit information to the other functional units.

The first communication interface 520 can include different implementations depending on which functional units are being interfaced with the first communication unit 510. The first communication interface 520 can be implemented with technologies and techniques similar to the implementation of the first control interface 514.

The first device 501 can include a first user interface 502. The first user interface 502 allows a user (not shown) to interface and interact with the first device 501. The first user interface 502 can include a first user input (not shown). The first user input can include touch screen, gestures, motion detection, buttons, slicers, knobs, virtual buttons, voice recognition controls, or any combination thereof.

The first user interface 502 can include a first display interface 503. The first display interface 503 can allow the user to interact with the first user interface 502. The first display interface 503 can include a display, a video screen, a speaker, or any combination thereof.

The first control unit 508 can operate with the first user interface 502 to display video information generated by the video processing system 100 on the first display interface 503. The first control unit 508 can also execute the first software 512 for the other functions of the video processing system 100, including receiving video information from the first storage unit 504 for displaying on the first display interface 503. The first control unit 508 can further execute the first software 512 for interaction with the communication link 530 via the first communication unit 510.

For illustrative purposes, the first device 501 can be partitioned having the first user interface 502, the first storage unit 504, the first control unit 508, and the first communication unit 510, although it is understood that the first device 501 can have a different partition. For example, the first software 512 can be partitioned differently such that some or all of its function can be in the first control unit 508 and the first communication unit 510. In addition, the first device 501 can include other functional units not shown in FIG. 1 for clarity.

The video processing system 100 can include the second device 541. The second device 541 can be optimized for implementing the present invention in a multiple device embodiment with the first device 501. The second device 541 can provide the additional or higher performance processing power compared to the first device 501.

The second device 541 can include a second control unit 548. The second control unit 548 can include a second control interface 554. The second control unit 548 can execute a second software 552 to provide the intelligence of the video processing system 100.

The second control unit 548 can be implemented in a number of different manners. For example, the second control unit 548 can be a processor, an embedded processor, a microprocessor, a hardware control logic, a hardware finite state machine (FSM), a digital signal processor (DSP), or a combination thereof.

The second control interface 554 can be used for communication between the second control unit 548 and other functional units in the second device 541. The second control interface 554 can also be used for communication that is external to the second device 541.

The second control interface 554 can receive information from the other functional units or from external sources, or can transmit information to the other functional units or to external destinations. The external sources and the external destinations refer to sources and destinations external to the second device 541.

The second control interface 554 can be implemented in different ways and can include different implementations depending on which functional units or external units are being interfaced with the second control interface 554. For example, the second control interface 554 can be implemented with electrical circuitry, microelectromechanical systems (MEMS), optical circuitry, wireless circuitry, wireline circuitry, or a combination thereof.

The second device 541 can include a second storage unit 544. The second storage unit 544 can store the second software 552. The second storage unit 544 can also store the relevant information, such as images, syntax information, video, profiles, display preferences, sensor data, or any combination thereof.

The second storage unit 544 can be a volatile memory, a nonvolatile memory, an internal memory, an external memory, or a combination thereof. For example, the second storage unit 544 can be a nonvolatile storage such as non-volatile random access memory (NVRAM), Flash memory, disk storage, or a volatile storage such as static random access memory (SRAM).

The second storage unit 544 can include a second storage interface 558. The second storage interface 558 can be used for communication between the second storage unit 544 and other functional units in the second device 541. The second storage interface 558 can also be used for communication that is external to the second device 541.

The second storage interface 558 can receive information from the other functional units or from external sources, or can transmit information to the other functional units or to external destinations. The external sources and the external destinations refer to sources and destinations external to the second device 541.

The second storage interface 558 can include different implementations depending on which functional units or external units are being interfaced with the second storage unit 544. The second storage interface 558 can be implemented with technologies and techniques similar to the implementation of the second control interface 554.

The second device 541 can include a second imaging unit 546. The second imaging unit 546 can capture the video source 108 from the real world. The first imaging unit 506 can include a digital camera, a video camera, an optical sensor, or any combination thereof.

The second imaging unit 546 can include a second imaging interface 556. The second imaging interface 556 can be used for communication between the second imaging unit 546 and other functional units in the second device 541.

The second imaging interface 556 can receive information from the other functional units or from external sources, or can transmit information to the other functional units or to external destinations. The external sources and the external destinations refer to sources and destinations external to the second device 541.

The second imaging interface 556 can include different implementations depending on which functional units or external units are being interfaced with the second imaging unit 546. The second imaging interface 556 can be implemented with technologies and techniques similar to the implementation of the first control interface 514.

The second device 541 can include a second communication unit 550. The second communication unit 550 can enable external communication to and from the second device 541. For example, the second communication unit 550 can permit the second device 541 to communicate with the first device 501, an attachment, such as a peripheral device or a computer desktop, and the communication link 530.

The second communication unit 550 can also function as a communication hub allowing the second device 541 to function as part of the communication link 530 and not limited to be an end point or terminal unit to the communication link 530. The second communication unit 550 can include active and passive components, such as microelectronics or an antenna, for interaction with the communication link 530.

The second communication unit 550 can include a second communication interface 560. The second communication interface 560 can be used for communication between the second communication unit 550 and other functional units in the second device 541. The second communication interface 560 can receive information from the other functional units or can transmit information to the other functional units.

The second communication interface 560 can include different implementations depending on which functional units are being interfaced with the second communication unit 550. The second communication interface 560 can be implemented with technologies and techniques similar to the implementation of the second control interface 554.

The second device 541 can include a second user interface 542. The second user interface 542 allows a user (not shown) to interface and interact with the second device 541. The second user interface 542 can include a second user input (not shown). The second user input can include touch screen, gestures, motion detection, buttons, slicers, knobs, virtual buttons, voice recognition controls, or any combination thereof.

The second user interface 542 can include a second display interface 543. The second display interface 543 can allow the user to interact with the second user interface 542. The second display interface 543 can include a display, a video screen, a speaker, or any combination thereof.

The second control unit 548 can operate with the second user interface 542 to display information generated by the video processing system 100 on the second display interface 543. The second control unit 548 can also execute the second software 552 for the other functions of the video processing system 100, including receiving display information from the second storage unit 544 for displaying on the second display interface 543. The second control unit 548 can further execute the second software 552 for interaction with the communication link 530 via the second communication unit 550.

For illustrative purposes, the second device 541 can be partitioned having the second user interface 542, the second storage unit 544, the second control unit 548, and the second communication unit 550, although it is understood that the second device 541 can have a different partition. For example, the second software 552 can be partitioned differently such that some or all of its function can be in the second control unit 548 and the second communication unit 550. In addition, the second device 541 can include other functional units not shown in FIG. 1 for clarity.

The first communication unit 510 can couple with the communication link 530 to send information to the second device 541 in the first device transmission 532. The second device 541 can receive information in the second communication unit 550 from the first device transmission 532 of the communication link 530.

The second communication unit 550 can couple with the communication link 530 to send video information to the first device 501 in the second device transmission 534. The first device 501 can receive video information in the first communication unit 510 from the second device transmission 534 of the communication link 530. The video processing system 100 can be executed by the first control unit 508, the second control unit 548, or a combination thereof.

The functional units in the first device 501 can work individually and independently of the other functional units. For illustrative purposes, the video processing system 100 is described by operation of the first device 501. It is understood that the first device 501 can operate any of the modules and functions of the video processing system 100. For example, the first device 501 can be described to operate the first control unit 508.

The functional units in the second device 541 can work individually and independently of the other functional units. For illustrative purposes, the video processing system 100 can be described by operation of the second device 541. It is understood that the second device 541 can operate any of the modules and functions of the video processing system 100. For example, the second device 541 is described to operate the second control unit 548.

For illustrative purposes, the video processing system 100 is described by operation of the first device 501 and the second device 541. It is understood that the first device 501 and the second device 541 can operate any of the modules and functions of the video processing system 100. For example, the first device 501 is described to operate the first control unit 508, although it is understood that the second device 541 can also operate the first control unit 508.

The video processing system 100 can include the first software 512 of the first device 501. The first control unit 508 can execute the first software 512 to receive the video bitstream 110 of FIG. 1. The video processing system 100 can include the second software 552 of the second device 541. The second control unit 548 can execute the second software 552 to receive the video bitstream 110. The video processing system 100 can be partitioned between the first software 512 and the second software 552.

In an illustrative example, the video processing system 100 can include the video encoder 102 on the first device 501 and the video decoder 104 on the second device 541. The video decoder 104 can include the display processor 118 of FIG. 1 and the display interface 120 of FIG. 1. Depending on the size of the first storage unit 504, the first software 512 can include additional modules of the video processing system 100.

The first control unit 508 can operate the first communication unit 510 to send the video bitstream 110 to the second device 541. The first control unit 508 can operate the first software 512 to operate the first imaging unit 506. The second communication unit 550 can send the video stream 112 of FIG. 1 to the first device 501 over the communication link 530.

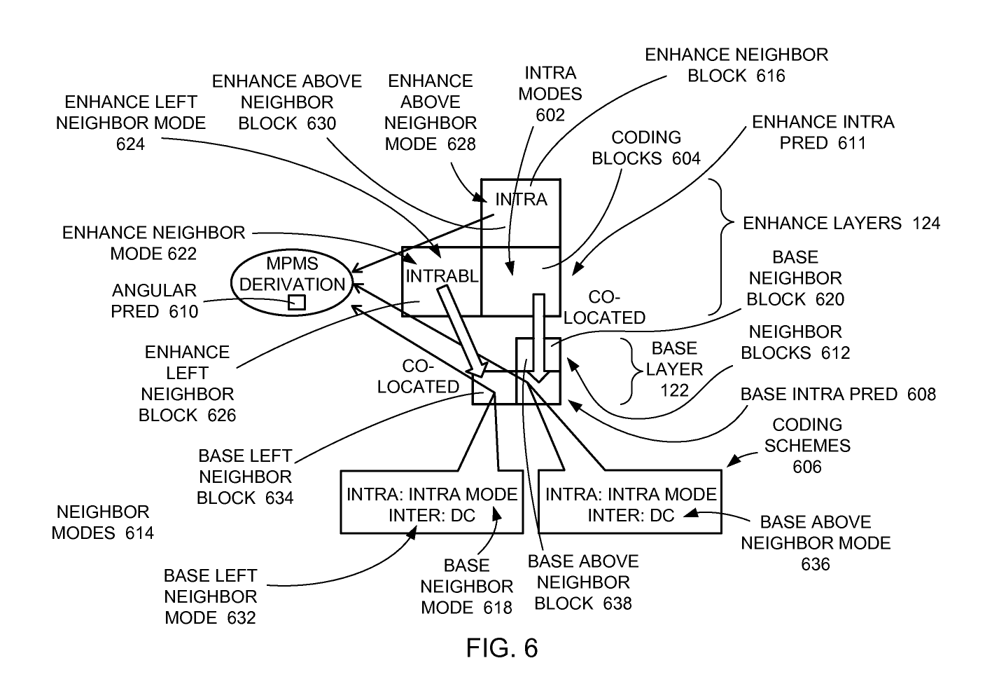

Referring now to FIG. 6, therein is shown an exemplary diagram illustrating derivation of prediction for intra modes 602 of coding blocks 604. The intra modes 602 are defined as information employed in encoding of video data for video compression to improve compression efficiency. The coding blocks 604 are defined as groups of picture elements, pixels, or smallest addressable elements in a display device that are processed using methods of reducing redundancy in video data.

For example, FIG. 6 depicts a proposed derivation of the intra modes 602 for the enhancement layers 124 in Scalable High Efficiency Video Coding (SHVC). Also for example, the intra modes 602 can be inter-layer intra most probable modes (MPM) for the enhancement layers 124.

Further, for example, the proposed derivation may be non-Tool Experiment 5 (non-TE5) or may not be applicable for TE5. TE5 includes test models or reference software for SHVC. TE5 can include inter-layer syntax prediction using the base layer 122 of High Efficiency Video Coding (HEVC).

In the embodiments described herein for the coding units 304 of FIG. 3 of the enhancement layers 124 that are intra coded, the derivation of the intra modes 602 can be modified to use the intra modes 602 of the base layer 122 that are intra coded. As will be subsequently described, experimental results of the embodiments are shown comparing to the SHVC test Model under Consideration code version 0.1.1 (SMuC0.1.1).

The experimental results show that Bjontegaard Distortion-rate (BD-rate) numbers for combined BL+EL are −0.31% for luminance component Y, −0.12% for chrominance component U, and −0.10% for chrominance component V in All Intra (AI) configuration 2×. The experimental results also show that the BD-rate numbers are −0.13% for Y, 0.11% for U, and 0.09% for V in AI 1.5×.

YUV is a color space typically used as part of a color image pipeline. YUV includes luminance component Y and chrominance components U and V. The terms “2×” and “1.5×” indicate base/enhancement layer spatial resolution ratios for spatial scalability. These terms refer to resolution ratios between the enhancement layers 124 and the base layer 122. For example, “2×” means that each dimension of the width and the height of the enhancement layers 124 is twice that of the base layer 122.

The derivation of the intra modes 602 is a process that can be employed for encoding and decoding in the video encoder 102 of FIG. 1 and the video decoder 104 of FIG. 1, respectively. For example, the derivation of the intra modes 602 can include an MPM derivation.

The derivation of the intra modes 602 is for modes of the coding blocks 604 including the coding units 304 or the prediction units 402 of FIG. 4. The intra modes 602 can include intra prediction modes. The intra prediction modes use a spatial coding method that uses data from neighboring prediction blocks previously encoded to minimize residual between prediction and original blocks. The term “neighboring” refers to blocks within one of the frames 109 of FIG. 1 that are encoded using enhancement neighbor modes.

The embodiments can include a number of coding schemes 606, which are defined as methods of reducing redundancy in video data. For example, the coding schemes 606 can include SHVC coding schemes.

The coding schemes 606 can be employed in multiple layers including the base layer 122 and the enhancement layers 124. For example, the base layer 122 can be encoded using HEVC or Advanced Video Coding (AVC). Also for example, the enhancement layers 124 can be encoded by using tools from HEVC.

A base intra prediction 608 for the base layer 122 can include an angular prediction 610 based on neighboring reconstructed pixels or reference samples from the enhancement layers 124. The base intra prediction 608 is defined as a coding process that employs the intra prediction modes previous described.

The angular prediction 610 is defined as a method of intra prediction based on a prediction direction. The prediction direction is used to predict a block directionally from spatially neighboring samples.

An enhancement intra prediction 611 for the enhancement layers 124 can also include intra prediction information from the base layer 122 using sample or reference blocks from the base layer 122 that are up-sampled and co-located or col-located as prediction. The enhancement intra prediction 611 is defined as a coding process that employs the intra prediction modes previous described.

The term “up-sampled” refers to a block with an increase in a number of picture elements, pixels, or smallest addressable elements in a display device from its original resolution. A co-located sample refers to a corresponding sample in a reference layer for a current layer. For example, the reference layer and the current layer can be the base layer 122 and the enhancement layers 124, respectively. The corresponding sample reflects the same or similar content represented by samples in both layers.

In SMuC0.1.1, an Enhancement Layer (EL) reuses HEVC intra mode coding scheme. Due to the similarities between the content of EL and an up-scaled Base Layer (BL), there is a large correlation between the intra prediction modes of EL and BL. Several proposals in using such intra prediction mode correlation are studied in TE5 Section 5.1. [1].

The term “up-scaled” refers to an up-sampled Base Layer generated using previous encoded knowledge or information to have the same size or the same resolution as an Enhancement Layer. In such a case, the size of the Enhancement Layer is larger than the up-sampled Base Layer's original size.

With the macro SVC_BL_CAND_INTRA in SMuC0.1.1 enabled, co-located BL intra prediction mode is used for an MPM derivation if co-located BL CU is intra coded. Otherwise, the MPM derivation stays the same as HEVC. The MPM derivation is as follows.

If co-located BL intra prediction mode is different from left and above neighbors in EL, co-located BL intra prediction mode is set to be the first MPM followed by intra modes of left and above neighbors, respectively. Otherwise, co-located BL intra prediction mode is equal to either left or above neighbor of EL. HEVC MPM derivation is applied.

The macro SVC_BL_CAND_INTRA is used for testing purposes in reference software. Acronyms “SVC”, “BL”, “CAND”, and “INTRA” stand for scalability video coding, base layer, candidate, and intra prediction, respectively. The macro can be used for prediction of a block in the EL using a block that is co-located in the BL.

Since an intra base layer (IntraBL) mode is treated as non-intra coded in SMuC, when either left or above neighbor is an Intra Base Layer (IntraBL) mode, it is tagged as “unavailable” and treated as a direct current (DC) mode in the MPM derivation. However, there could be cases that co-located BL CUs for left and above neighbors can be used for intra prediction mode derivation. Accordingly, a contribution of the embodiments described herein proposes to use intra mode from co-located BL neighbors for the MPM derivation.

The IntraBL mode is defined as an intra prediction mode in the enhancement layers 124. For example, the IntraBL mode can also include TextureRL, the semantics of which is described by “texture_rl_flag” in a working draft of the “SHVC Test Model 1 (SHM 1)”, JCTVC-L1007 v3, H.7.4.9.5.

A motivation of a proposed solution of the embodiments described herein applies to a case when the intra modes 602 including MPMs are derived from neighbor blocks 612, but sometimes the neighbor blocks 612 are not available. The neighbor blocks 612 are defined as groups of picture elements, pixels, or smallest addressable elements in a display device that are next to each other and within one of the frames 109 that are encoded using the intra modes 602. The neighbor blocks 612 can include the coding units 304 or the prediction units 402.

The neighbor modes 614 are defined as coding methods of reducing redundancy in video data for the neighbor blocks 612. The neighbor modes 614 can include digital video compression techniques including spatial and temporal compression. Spatial compression involves removing or reordering information about a group of picture elements to conserve file space. Temporal compression operates across time by comparing one still frame with an adjoining frame and, instead of saving all the information about each frame into the digital video file, only saves information about differences between frames.

The neighbor modes 614 can include compression techniques including an inter mode, the intra mode, and the IntraBL mode. The inter mode is a temporal compression that uses one or more earlier or later frames in a sequence to compress a current frame. The intra mode is a spatial compression that uses only a current frame.

If an enhancement neighbor block 616 is not available in the enhancement layers 124 for compression of the coding blocks 604, the intra modes 602 of the coding blocks 604 in the enhancement layers 124 are determined based on a base neighbor mode 618 of a base neighbor block 620 in the base layer 122. The enhancement neighbor block 616 is defined as a group of picture elements, pixels, or smallest addressable elements in a display device, wherein the group is adjacent to and within the same frame of the coding blocks 604 in the enhancement layers 124.

The enhancement neighbor block 616 can include the inter mode, the intra mode, or the IntraBL mode. In this case, the default method in SMuC sets unavailable neighbors as the DC mode. The inter mode is defined as a temporal coding method that uses a coding process for blocks in a video frame by employing data from blocks in other video frames to minimize residual between prediction and original blocks. The intra mode is defined as a spatial coding method that uses a coding process for blocks in only a current video frame to minimize residual between prediction and original blocks.

In the embodiments described herein, when the enhancement neighbor block 616 is not available, information from the base layer 122 is used for prediction of intra prediction mode in the enhancement layers 124. The proposed solution of the embodiments applies to the derivation of the intra modes 602 including MPMs of the coding blocks 604. The derivation of the intra modes 602 is determined for or based on each of the neighbor blocks 612. The derivation of the intra modes 602 is determined based on the enhancement left neighbor mode 624 and the enhancement above neighbor mode 628 of the neighbor blocks 612.

The base neighbor mode 618 is defined as a coding method of reducing redundancy in video data for the neighbor blocks 612 in the base layer 122. The base neighbor block 620 is defined as a group of picture elements, pixels, or smallest addressable elements in a display device, wherein the group is adjacent to and within the same frame of the coding blocks 604 in the base layer 122.

If the base neighbor mode 618 of the base neighbor block 620 col-located in the base layer 122 is intra coded or the intra mode, the base neighbor mode 618 is used. In this case, the intra modes 602 of the coding blocks 604 in the enhancement layers 124 are assigned to be the intra mode, which is based on the base neighbor mode 618.

Otherwise, the intra modes 602 of the coding blocks 604 are determined using the direct current (DC) mode, which is defined as a compression method that uses an average value of reference samples for prediction. Each of the reference samples includes any number of picture elements, pixels, or smallest addressable elements in a display device. The DC mode is an intra prediction mode. The DC mode employs the mean of left and above values of the reference samples to predict the coding blocks 604.

Otherwise, if the enhancement neighbor block 616 is available in the enhancement layers 124, the intra modes 602 of the coding blocks 604 in the enhancement layers 124 are determined based on an enhancement neighbor mode 622 of the enhancement neighbor block 616 in the enhancement layers 124. The enhancement neighbor mode 622 is defined as a coding method of reducing redundancy in video data for the neighbor blocks 612 in the enhancement layers 124.

If the enhancement neighbor mode 622 is the intra mode, the enhancement neighbor mode 622 is used. In this case, the intra modes 602 of the coding blocks 604 are assigned to be the intra mode, which is based on the enhancement neighbor mode 622.

In the proposed solution, the macro SVC_BL_CAND_INTRA is enabled. The proposed solution includes a change to an existing coding method for the derivation of the intra modes 602. The change about or to the neighbor modes 614 is as follows.

The derivation of the intra modes 602 is determined based on an enhancement left neighbor mode 624 of an enhancement left neighbor block 626 in the enhancement layers 124. The enhancement left neighbor mode 624 is the enhancement neighbor mode 622 of or associated with the enhancement left neighbor block 626. The enhancement left neighbor block 626 is the enhancement neighbor block 616 that is to the left of the coding blocks 604 in the enhancement layers 124.

The derivation of the intra modes 602 is also determined based on an enhancement above neighbor mode 628 of an enhancement above neighbor block 630 in the enhancement layers 124. The enhancement above neighbor mode 628 is the enhancement neighbor mode 622 of the enhancement above neighbor block 630. The enhancement above neighbor block 630 is the enhancement neighbor block 616 that is above the coding blocks 604 in the enhancement layers 124. The enhancement neighbor modes previously mentioned include the enhancement above neighbor mode 628 and the enhancement left neighbor mode 624.

The derivation of the intra modes 602 is also determined based on a base left neighbor mode 632 of a base left neighbor block 634 co-located in the base layer 122. The base left neighbor mode 632 is the base neighbor mode 618 of the base left neighbor block 634. The base left neighbor block 634 is the base neighbor block 620 that is to the left of the coding blocks 604 co-located in the base layer 122.

The derivation of the intra modes 602 is also determined based on a base above neighbor mode 636 of a base above neighbor block 638 co-located in the base layer 122. The base above neighbor mode 636 is the base neighbor mode 618 of the base above neighbor block 638. The base above neighbor block 638 is the base neighbor block 620 that is above the coding blocks 604 co-located in the base layer 122.

If the enhancement left neighbor mode 624 or the enhancement above neighbor mode 628 is the IntraBL mode and the base left neighbor mode 632 or the base above neighbor mode 636, respectively, is intra coded or the intra mode, the intra mode is used for the enhancement left neighbor mode 624 or the enhancement above neighbor mode 628, respectively. In this case, the intra mode is used for the derivation of the intra modes 602.

Otherwise, the enhancement left neighbor mode 624 or the enhancement above neighbor mode 628 is set to the DC mode. If the enhancement left neighbor mode 624 or the enhancement above neighbor mode 628 is not the IntraBL mode and the base left neighbor mode 632 or the base above neighbor mode 636, respectively, is not the intra mode, the DC mode is used to set the enhancement left neighbor mode 624 or the enhancement above neighbor mode 628, respectively.

It has been found that the derivation of the intra modes 602 as described for the proposed solution further uses information of the base layer 122 including the base left neighbor mode 632 and the base above neighbor mode 636. Thus, coding efficiency of intra mode coding is further improved. The improved coding efficiency provides further reduction in bit rates of the frames 109 without quality degradation.

It has also been found that the contribution of the proposed solution provides the derivation of the intra modes 602 based on the IntraBL mode, the base left neighbor mode 632, and the base above neighbor mode 636 provides BD-rate saving or improved BD-rate numbers as reported by simulation or the experimental results previously described. Therefore, adoption of the proposed solution is recommended for SHVC.

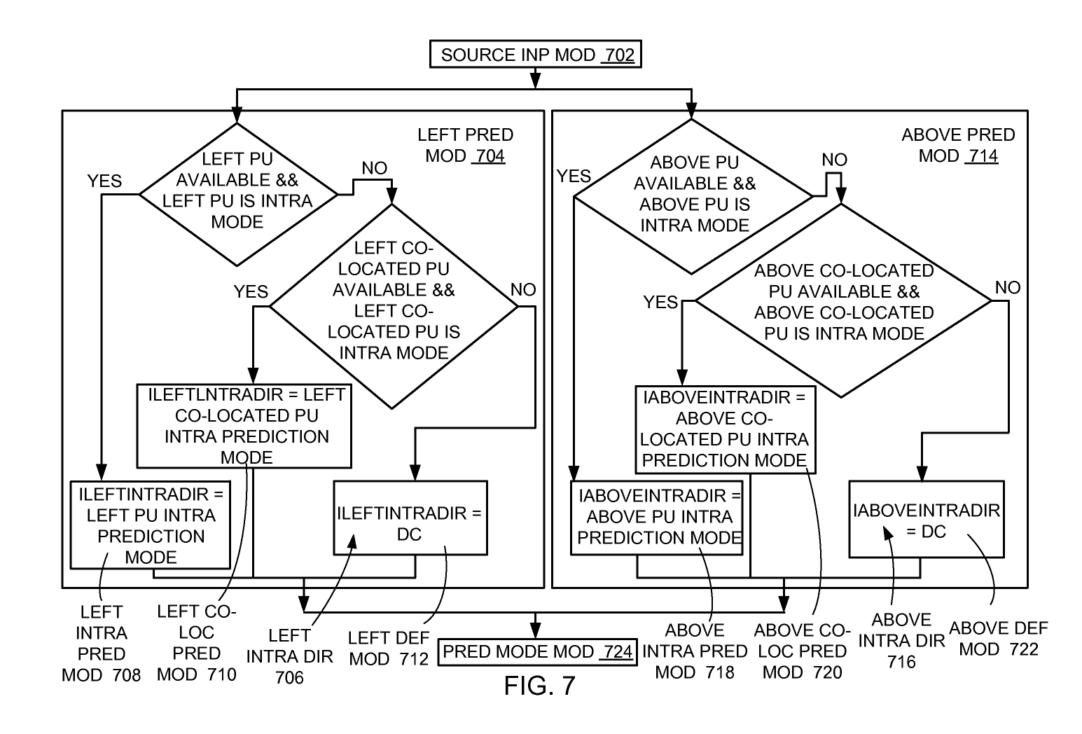

Referring now to FIG. 7, therein is shown an exemplary control flow of the prediction mechanism for the derivation of the intra modes 602 of FIG. 6. FIG. 7 depicts a flow chart of the proposed solution for the derivation of the intra modes 602 for the enhancement layers 124 of FIG. 1. For example, the derivation of the intra modes 602 can be employed in SHVC.

FIG. 7 demonstrates the present invention. Compared to other methods including HEVC for deriving Most Probable Mode (MPM) for Intra mode coding, the present invention introduces additional conditions for neighboring intra modes as shown in FIG. 7. The present invention includes an idea that whenever a current layer's neighbor intra mode is not valid, a co-located block will be used as a supplementary source.

The video processing system 100 of FIG. 1 includes a source input module 702 for receiving the frames 109 of FIG. 1 from the video source 108 of FIG. 1. The video processing system 100 includes the video stream 112 of FIG. 1. The video stream 112 can then be processed by other modules in the video encoder 102 of FIG. 1, some of which will be subsequently described below.

The video processing system 100 includes a left prediction module 704 for predicting a left intra direction 706 for the coding blocks 604 of FIG. 6 of the frames 109 in the video source 108. The left intra direction 706 is predicted based on the enhancement left neighbor block 626 of FIG. 6, the enhancement left neighbor mode 624 of FIG. 6, the base left neighbor block 634 of FIG. 6, and the base left neighbor mode 632 of FIG. 6.

The left intra direction 706 is defined as a spatial coding method that uses a coding process for blocks in only a current video frame to minimize residual between prediction and original blocks, wherein the blocks are coded using coding information from other blocks that are to the left of the blocks. The left intra direction 706 is associated with one of the neighbor blocks 612 of FIG. 6 to the left of the coding blocks 604 in the enhancement layers 124.

The left prediction module 704 includes a left intra prediction module 708 for determining the left intra direction 706 based on the enhancement left neighbor block 626 and the enhancement left neighbor mode 624. If the enhancement left neighbor block 626 is available and the enhancement left neighbor mode 624 is the intra mode, the left intra prediction module 708 assigns the left intra direction 706 to be equal to the enhancement left neighbor mode 624. Availability of the enhancement left neighbor block 626 refers to the enhancement left neighbor block 626 having the enhancement left neighbor mode 624 with valid information as opposed to having no information or no prediction modes.

The left prediction module 704 includes a left co-located prediction module 710 for determining the left intra direction 706 based on the enhancement left neighbor block 626, the enhancement left neighbor mode 624, the base left neighbor block 634, and the base left neighbor mode 632. If the enhancement left neighbor block 626 is not available or the enhancement left neighbor mode 624 is not the intra mode, the left co-located prediction module 710 determines the left intra direction 706 based on the base left neighbor block 634, the base left neighbor mode 632, and the DC mode.

If the base left neighbor block 634 co-located in the base layer 122 of FIG. 1 is available and the base left neighbor mode 632 is the intra mode, the left co-located prediction module 710 assigns the left intra direction 706 to be equal to the base left neighbor mode 632. Availability of the base left neighbor block 634 co-located in the base layer 122 refers to the base left neighbor block 634 having the base left neighbor mode 632 with valid information as opposed to having no information or no prediction modes.

The left prediction module 704 includes a left default module 712 for determining the left intra direction 706 based on the enhancement left neighbor block 626, the enhancement left neighbor mode 624, the base left neighbor block 634, the base left neighbor mode 632, and the DC mode. If the base left neighbor block 634 co-located in the base layer 122 is not available or the base left neighbor mode 632 is not the intra mode, the left default module 712 determines the left intra direction 706 based on the DC mode.

If the base left neighbor block 634 co-located in the base layer 122 is not available or the base left neighbor mode 632 is not the intra mode, the left default module 712 assigns the left intra direction 706 to be equal to the DC mode. This is a default prediction mode when none of the conditions previously described in the left prediction module 704 is true.

The video processing system 100 includes an above prediction module 714 for predicting an above intra direction 716 for the coding blocks 604 of the frames 109 in the video source 108. The above intra direction 716 is predicted based on the enhancement above neighbor block 630 of FIG. 6, the enhancement above neighbor mode 628 of FIG. 6, the base above neighbor block 638 of FIG. 6, and the base above neighbor mode 636 of FIG. 6.

The above intra direction 716 is defined as a spatial coding method that uses a coding process for blocks in only a current video frame to minimize residual between prediction and original blocks, wherein the blocks are coded using coding information from other blocks that are to the above of the blocks. The above intra direction 716 is associated with one of the neighbor blocks 612 above the coding blocks 604 in the enhancement layers 124.

The above prediction module 714 includes an above intra prediction module 718 for determining the above intra direction 716 based on the enhancement above neighbor block 630 and the enhancement above neighbor mode 628. If the enhancement above neighbor block 630 is available and the enhancement above neighbor mode 628 is the intra mode, the above intra prediction module 718 assigns the above intra direction 716 to be equal to the enhancement above neighbor mode 628. Availability of the enhancement above neighbor block 630 refers to the enhancement above neighbor block 630 having the enhancement above neighbor mode 628 with valid information as opposed to having no information or no prediction modes.

The above prediction module 714 includes an above co-located prediction module 720 for determining the above intra direction 716 based on the enhancement above neighbor block 630, the enhancement above neighbor mode 628, the base above neighbor block 638, and the base above neighbor mode 636. If the enhancement above neighbor block 630 is not available or the enhancement above neighbor mode 628 is not the intra mode, the above co-located prediction module 720 determines the above intra direction 716 based on the base above neighbor block 638, the base above neighbor mode 636, and the DC mode.

If the base above neighbor block 638 co-located in the base layer 122 is available and the base above neighbor mode 636 is the intra mode, the above co-located prediction module 720 assigns the above intra direction 716 to be equal to the base above neighbor mode 636. Availability of the base above neighbor block 638 co-located in the base layer 122 refers to the base above neighbor block 638 having the base above neighbor mode 636 with valid information as opposed to having no information or no prediction modes.

The above prediction module 714 includes an above default module 722 for determining the above intra direction 716 based on the enhancement above neighbor block 630, the enhancement above neighbor mode 628, the base above neighbor block 638, the base above neighbor mode 636, and the DC mode. If the base above neighbor block 638 co-located in the base layer 122 is not available or the base above neighbor mode 636 is not the intra mode, the above default module 722 determines the above intra direction 716 based on the DC mode.

If the base above neighbor block 638 co-located in the base layer 122 is not available or the base above neighbor mode 636 is not the intra mode, the above default module 722 assigns the above intra direction 716 to be equal to the DC mode. This is a default prediction mode when none of the conditions previously described in the above prediction module 714 is true.

The video processing system 100 includes a prediction mode module 724 for generating the intra modes 602 based on a number of prediction modes including but not limited to the left intra direction 706, the above intra direction 716, the DC mode, and an angular mode. The angular mode is defined as a prediction method using the angular prediction 610 of FIG. 6.

For example, the intra modes 602 can be determined by comparing the enhancement left neighbor mode 624 and the enhancement above neighbor mode 628. Also for example, the intra modes 602 can be determined by checking if the enhancement left neighbor mode 624 is the angular mode.

The prediction mode module 724 can determine any number of the intra modes 602. For example, the prediction mode module 724 can generate three of the intra modes 602 for the enhancement layers 124.

The source input module 702, the left prediction module 704, the above prediction module 714, and the prediction mode module 724 can be implemented in the video encoder 102 for generating the video bitstream 110 of FIG. 1 for the video decoder 104 of FIG. 1 to receive and decode. The video decoder 104 can generate the video stream 112 for displaying on a device such as the display interface 120 of FIG. 1.

Simulation has been performed for the proposed solution. Simulation of the proposed solution is implemented in SMuC0.1.1 and tested using All Intra (AI) configurations suggested in TE5 [1]. Running time, including encoding and decoding times, is not available because simulation is run in a cluster. Simulation is performed using Class A and Class B test sequences with different resolution videos from each other.

In a case of AI HEVC 2×, the simulation results show that BD-rate numbers for Y, U, and V are −0.23%, −0.04%, and 0.06%, respectively, for Class A test sequences. The simulation results show that BD-rate numbers for Y, U, and V are −0.34%, −0.16%, and −0.17%, respectively, for Class B test sequences. Overall results for a combination of the enhancement layers 124 and the base layer 122 show that BD-rate numbers for Y, U, and V are −0.31%, −0.12%, and −0.10%, respectively. Overall results for the enhancement layers 124 show that BD-rate numbers for Y, U, and V are −0.55%, −0.16%, and −0.12%, respectively. In this case, the simulation results show that the output of the base layer 122 matches reference images including a single layer of HEVC version 1.

In a case of AI HEVC 1.5×, the simulation results show that BD-rate numbers for Y, U, and V are −0.13%, 0.11%, and 0.09%, respectively, for Class B test sequences. Overall results for a combination of the enhancement layers 124 and the base layer 122 show that BD-rate numbers for Y, U, and V are −0.13%, 0.11%, and 0.09%, respectively. Overall results for the enhancement layers 124 show that BD-rate numbers for Y, U, and V are −0.32%, 0.33%, and 0.29%, respectively. In this case, the simulation results show that the output of the base layer 122 matches reference images including a single layer of HEVC version 1.

Since the intra prediction mode of the base layer 122 is used for the enhancement layers 124, there is parsing dependency on the base layer 122. To avoid the dependency, mode-dependent coefficient scan (MDCS) is disabled or off for the enhancement layers 124. The results with MDCS off are summarized below.

In a case of AI HEVC 2×, the simulation results show that BD-rate numbers for Y, U, and V are −0.17%, 0.09%, and 0.16%, respectively, for Class A test sequences. The simulation results show that BD-rate numbers for Y, U, and V are −0.18%, 0.05%, and 0.13%, respectively, for Class B test sequences. Overall results for a combination of the enhancement layers 124 and the base layer 122 show that BD-rate numbers for Y, U, and V are −0.18%, 0.06%, and 0.14%, respectively. Overall results for the enhancement layers 124 show that BD-rate numbers for Y, U, and V are −0.33%, 0.13%, and 0.26%, respectively. In this case, the simulation results show that the output of the base layer 122 matches reference images including a single layer of HEVC version 1.

In a case of AI HEVC 1.5×, the simulation results show that BD-rate numbers for Y, U, and V are −0.12%, 0.13%, and 0.14%, respectively, for Class B test sequences. Overall results for a combination of the enhancement layers 124 and the base layer 122 show that BD-rate numbers for Y, U, and V are −0.12%, 0.13%, and 0.14%, respectively. Overall results for the enhancement layers 124 show that BD-rate numbers for Y, U, and V are −0.30%, 0.37%, and 0.40%, respectively. In this case, the simulation results show that the output of the base layer 122 matches reference images including a single layer of HEVC version 1.

Functions or operations of the video encoder 102 in the video processing system 100 as described above can be implemented using modules. The functions or the operations of the video encoder 102 can be implemented in hardware, software, or a combination thereof. The modules can be implemented using the first user interface 502 of FIG. 5, the first storage unit 504 of FIG. 5, the first imaging unit 506 of FIG. 5, the first control unit 508 of FIG. 5, the first communication unit 510 of FIG. 5, or a combination thereof.

For example, the source input module 702 can be implemented with the first user interface 502, the first storage unit 504, the first imaging unit 506, and the first control unit 508 for receiving the frames 109 from the video source 108. Also for example, the left intra prediction module 708 can be implemented with the first storage unit 504, the first imaging unit 506, and the first control unit 508 for determining the left intra direction 706.

For example, the left co-located prediction module 710 can be implemented with the first storage unit 504, the first imaging unit 506, and the first control unit 508 for determining the left intra direction 706. Also for example, the left default module 712 can be implemented with the first storage unit 504, the first imaging unit 506, and the first control unit 508 for determining the left intra direction 706.

For example, the above intra prediction module 718 can be implemented with the first storage unit 504, the first imaging unit 506, and the first control unit 508 for determining the above intra direction 716. Also for example, the above co-located prediction module 720 can be implemented with the first storage unit 504, the first imaging unit 506, and the first control unit 508 for determining the above intra direction 716.

For example, the above default module 722 can be implemented with the first storage unit 504, the first imaging unit 506, and the first control unit 508 for determining the above intra direction 716. Also for example, the prediction mode module 724 can be implemented with the first storage unit 504, the first imaging unit 506, and the first control unit 508 for generating the intra modes 602 based on the left intra direction 706 and the above intra direction 716.

The video processing system 100 is described with module functions or order as an example. The modules can be partitioned differently. Each of the modules can operate individually and independently of the other modules.

Furthermore, data generated in one module can be used by another module without being directly coupled to each other. Yet further, the modules can be implemented as hardware accelerators (not shown) within the first control unit 508 or the second control unit 548 of FIG. 5, or can be implemented as hardware accelerators (not shown) in the video encoder 102 or outside of the video encoder 102.

The source input module 702 can be coupled to the left intra prediction module 708, the left co-located prediction module 710, the left default module 712, the above intra prediction module 718, the above co-located prediction module 720, and the above default module 722. The left intra prediction module 708, the left co-located prediction module 710, the left default module 712, the above intra prediction module 718, the above co-located prediction module 720, and the above default module 722 can be coupled to the prediction mode module 724.

The physical transformation of generating the intra modes 602 based on the left intra direction 706 to generate the video bitstream 110 for the video decoder 104 to display on the device results in movement in the physical world, such as people using the video encoder 102 and the video decoder 104 based on the operation of the video processing system 100. As the movement in the physical world occurs, the movement itself creates additional information that is converted back to receiving the frames 109 from the video source 108 and determining the left intra direction 706 for the continued operation of the video processing system 100 and to continue the movement in the physical world.

It has been found that generation of the left intra direction 706 based on the base left neighbor block 634 and the base left neighbor mode 632 further provides improved efficiency of an intra-mode coding process. The intra-mode coding process is improved since the left intra direction 706 is assigned to be equal to the base left neighbor mode 632 when the base left neighbor block 634 co-located in the base layer 122 is available and the base left neighbor mode 632 is the intra mode. The left intra direction 706 assigned to be equal to the base left neighbor mode 632 reduces bit rates, thereby providing the improved efficiency of the intra-mode coding process without quality degradation.

It has also been found that generation of the above intra direction 716 based on the base above neighbor block 638 and the base above neighbor mode 636 further provides improved efficiency of the intra-mode coding process. The intra-mode coding process is improved since the above intra direction 716 is assigned to be equal to the base above neighbor mode 636 when the base above neighbor block 638 co-located in the base layer 122 is available and the base above neighbor mode 636 is the intra mode. The above intra direction 716 assigned to be equal to the base above neighbor mode 636 reduces bit rates, thereby providing the improved efficiency of the intra-mode coding process without quality degradation.

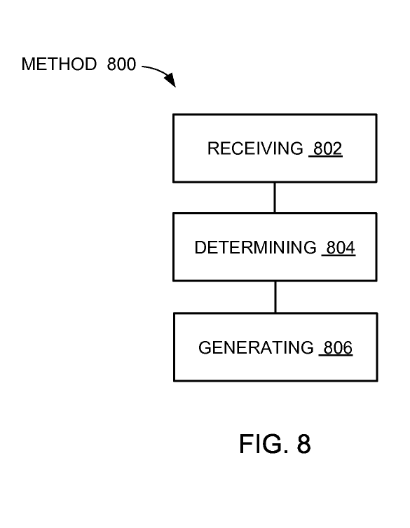

Referring now to FIG. 8, therein is shown a flow chart of a method 800 of operation of a video processing system in a further embodiment of the present invention. The method 800 includes: receiving a frame from a video source in a block 802; determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame in a block 804; and generating a prediction mode based on the left intra direction to generate a video bitstream for a video decoder to display on a device in a block 806.

Thus, it has been discovered that the video processing system 100 of the present invention furnishes important and heretofore unknown and unavailable solutions, capabilities, and functional aspects for a video processing system with prediction mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a video processing system comprising:
receiving a frame from a video source;
determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame; and
generating an intra mode for a coding block based on the left intra direction, the coding block is generated for a video bitstream for a video decoder to display on a device.

2. The method as claimed in claim 1 wherein determining the left intra direction includes assigning the left intra direction to be equal to the base left neighbor mode.

3. The method as claimed in claim 1 wherein determining the left intra direction includes determining the left intra direction if a base left neighbor block co-located in the base layer is available.

4. The method as claimed in claim 1 wherein determining the left intra direction includes determining the left intra direction if the base left neighbor mode is an intra mode.

5. The method as claimed in claim 1 wherein determining the left intra direction includes determining the left intra direction based on a direct current (DC) mode.

6. A method of operation of a video processing system comprising:
receiving a frame from a video source;
determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame;
determining an above intra direction based on an enhancement above neighbor mode associated with the enhancement layer and a base above neighbor mode associated with the base layer; and
generating an intra mode for a coding block based on the left intra direction and the above intra direction, the coding block is generated for a video bitstream for a video decoder to display on a device.

7. The method as claimed in claim 6 wherein:
determining the left intra direction includes assigning the left intra direction to be equal to the base left neighbor mode; and
determining the above intra direction includes assigning the above intra direction to be equal to the base above neighbor mode.

8. The method as claimed in claim 6 wherein:
determining the left intra direction includes determining the left intra direction if a base left neighbor block co-located in the base layer is available; and
determining the above intra direction includes determining the above intra direction if a base above neighbor block co-located in the base layer is available.

9. The method as claimed in claim 6 wherein:
determining the left intra direction includes determining the left intra direction if the base left neighbor mode is an intra mode; and
determining the above intra direction includes determining the above intra direction if the base above neighbor mode is the intra mode.

10. The method as claimed in claim 6 wherein:
determining the left intra direction includes determining the left intra direction based on a direct current (DC) mode; and
determining the above intra direction includes determining the above intra direction based on the DC mode.

11. A video processing system comprising:
a source input module for receiving a frame from a video source;
a left co-located prediction module, coupled to the source input module, for determining a left intra direction based on an enhancement left neighbor mode and a base left neighbor mode, the enhancement left neighbor mode associated with an enhancement layer and the base left neighbor mode associated with a base layer, the enhancement layer and the base layer formed from the frame; and
a prediction mode module, coupled to the left co-located prediction module, for generating an intra mode based on the left intra direction to generate a video bitstream for a video decoder to display on a device.

12. The system as claimed in claim 11 wherein the left co-located prediction module is for assigning the left intra direction to be equal to the base left neighbor mode.

13. The system as claimed in claim 11 wherein the left co-located prediction module is for determining the left intra direction if a base left neighbor block co-located in the base layer is available.

14. The system as claimed in claim 11 wherein the left co-located prediction module is for determining the left intra direction if the base left neighbor mode is an intra mode.

15. The system as claimed in claim 11 further comprising a left default module, coupled to the source input module, for determining the left intra direction based on a direct current (DC) mode.

16. The system as claimed in claim 11 further comprising:
an above co-located prediction module, coupled to the source input module, for determining an above intra direction based on an enhancement above neighbor mode associated with the enhancement layer and a base above neighbor mode associated with the base layer; and
wherein:
the prediction mode module is for generating the intra mode based on the left intra direction and the above intra direction.

17. The system as claimed in claim 16 wherein:
the left co-located prediction module is for assigning the left intra direction to be equal to the base left neighbor mode; and
the above co-located prediction module is for assigning the above intra direction to be equal to the base above neighbor mode.

18. The system as claimed in claim 16 wherein:
the left co-located prediction module is for determining the left intra direction if a base left neighbor block co-located in the base layer is available; and
the above co-located prediction module is for determining the above intra direction if a base above neighbor block co-located in the base layer is available.

19. The system as claimed in claim 16 wherein:
the left co-located prediction module is for determining the left intra direction if the base left neighbor mode is an intra mode; and
the above co-located prediction module is for determining the above intra direction if the base above neighbor mode is the intra mode.

20. The system as claimed in claim 16 further comprising:
a left default module, coupled to the source input module, for determining the left intra direction based on a direct current (DC) mode; and
an above default module, coupled to the source input module, for determining the above intra direction based on the DC mode.
